(19) United States
(12) Patent Application Publication
(10) Pub. No.: US 2022/0114525 A1
(43) Pub. Date: Apr. 14, 2022

(54) PEER GROUP BENCHMARK GENERATION AND PRESENTATION

(71) Applicant: Microsoft Technology Licensing, LLC, Redmond, WA (US)

(72) Inventors: Anjaneya MALPANI, Bellevue, WA (US); Dheepak RAMASWAMY, Seattle, WA (US); Anil Kumar REVURU, Sammamish, WA (US); Anupama Padmavathi CHALLA, Bellevue, WA (US); Muthukrishnan PARAMASIVAM, Seattle, WA (US); Jagadeesh Virupaksha HULIYAR, Redmond, WA (US)

(21) Appl. No.: 17/068,021

(22) Filed: Oct. 12, 2020

(51) Int. Cl. G06Q 10/06

(52) U.S. Cl. CPC G06Q 10/06393

(57) ABSTRACT

The disclosure herein describes generating and presenting a benchmark to a target entity. A peer group of entities associated with the target entity is determined based on at least one attribute of the target entity. Behavior data of the target entity and behavior data of the entities of the peer group is identified and the behavior data of the entities of the peer group is transformed using adjustment values, wherein the transformed behavior data differs from corresponding behavior data of the entities of the peer group by less than an accuracy threshold. Benchmark data of the benchmark associated with the behavior category is generated based on the behavior data associated with the target entity and the transformed behavior data associated with the entities of the peer group and the benchmark data of the benchmark is presented as a benchmark visualization via a user interface.

### BACKGROUND

Modern companies frequently seek out comparisons of their relative performance in various behaviors to performance by other similar companies to make informed decisions to improve those behaviors and become more competitive in their industries. While such companies can analyze behavior performance from internal data, using data from other peer companies may provide additional or enhanced insights regarding entire industries or markets. Obtaining similar behavior data from other companies in the same industry requires that many companies agree to share such data, which is unlikely in most cases as it probably requires the companies to share sensitive behavior data with competitors. Obtaining access to cross-industry behavior benchmarks without exposing sensitive data to such competitors presents a significant challenge for many modern companies.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for presenting a benchmark to a target entity is described. A peer group of entities associated with the target entity is determined based on at least one attribute of the target entity, wherein a quantity of entities in the determined peer group meets a peer group threshold associated with the target entity. Behavior data of the target entity associated with a behavior category and behavior data of the entities of the peer group associated with the behavior category is identified and the behavior data of the entities of the peer group is transformed using adjustment values, wherein transformed behavior data values of the transformed behavior data differ from corresponding behavior data values of the behavior data of the entities of the peer group by less than an accuracy threshold, whereby the behavior data values of the behavior data of the entities of the peer group are concealed from the target entity in the benchmark. Benchmark data of the benchmark associated with the behavior category is generated based on the behavior data associated with the target entity and the transformed behavior data associated with the entities of the peer group and the benchmark data of the benchmark is presented as a benchmark visualization via a user interface, wherein the benchmark visualization includes a visual representation of the behavior data of the target entity compared to the behavior data of the entities of the peer group.

### BRIEF DESCRIPTION OF THE DRAWINGS

The present description will be better understood from the following detailed description read in light of the accompanying drawings, wherein:

FIG. 1 is a block diagram illustrating a system configured for presenting benchmarks as benchmark visualizations to an entity according to an embodiment;

FIG. 2 is a flowchart illustrating a computerized method for presenting benchmarks as benchmark visualizations to an entity according to an embodiment;

FIG. 3 is a flowchart illustrating a computerized method for determining a peer group of a target entity for use in generating benchmarks according to an embodiment;

FIG. 4 is a flow chart illustrating a computerized method for adjusting behavior data of entities in a peer group to enhance privacy with respect to associated benchmarks according to an embodiment;

FIGS. 5A-C are diagrams illustrating exemplary graphical user interfaces (GUIs) for displaying benchmark visualizations according to an embodiment; and

FIG. 6 illustrates a computing apparatus according to an embodiment as a functional block diagram.

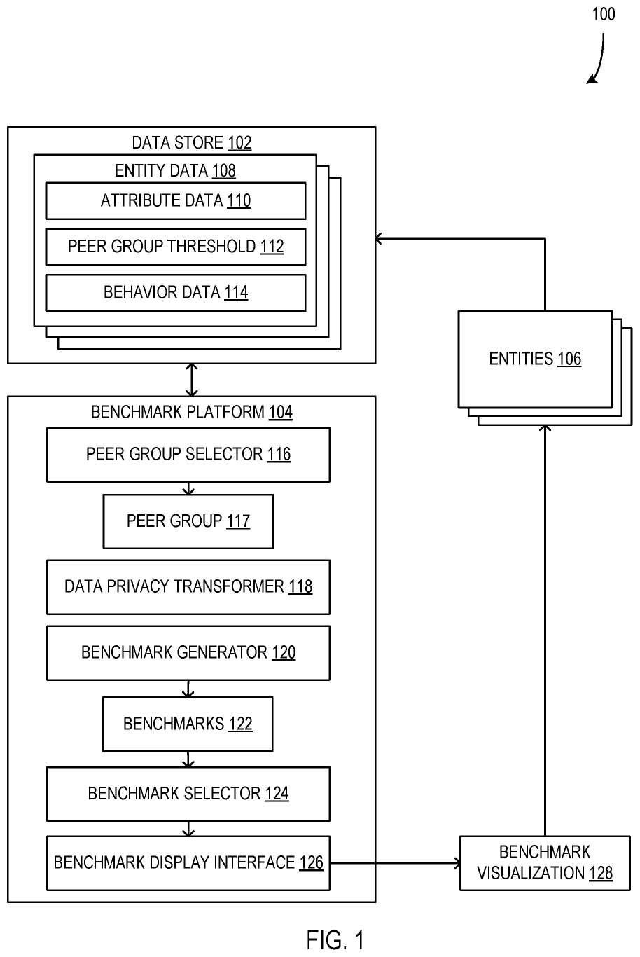

Corresponding reference characters indicate corresponding parts throughout the drawings. In FIGS. 1 to 6, the systems are illustrated as schematic drawings. The drawings may not be to scale.

### DETAILED DESCRIPTION

Aspects of the disclosure provide a computerized method and system for generating and presenting benchmarks associated with a peer group to a target entity. The disclosure includes identifying the entities of a peer group of the target entity based on matching entity attributes and behavior data of the target entity and the entities of the peer group. The behavior data of the peer group is then transformed in random, small ways to provide security and privacy for sensitive behavior data of the entities of the peer group while maintaining a level of accuracy for use in the benchmark to be generated. The behavior data of the target entity and the transformed behavior data of the peer group are used to create a benchmark that includes benchmark data that may be used to compare the performance of the target entity's behavior to the aggregated performance of the peer group with respect to the behavior. That benchmark may then be presented to the target entity in the form of one or more benchmark visualizations that enable the target entity to view relative performance indicators between its own performance and the aggregate performance of the peer group. Thus, the target entity is enabled to view benchmarks and use the benchmarks to make decisions about how to improve behaviors while protecting valuable and sensitive behavior data of the entities of the peer group.

The disclosure addresses the challenges of providing target entities such as companies and individuals with accurate, useful benchmark information that is based on data collected from a peer group of entities that are substantially similar to the target entities while securing a level of privacy for the data of the entities of the peer group. The disclosure makes use of defined scopes for attributes of entities to populate the peer group used for generating benchmarks and those scopes can be expanded in incremental ways to achieve a peer group of a required size and ensure that the entities in the peer group are substantially similar to the target entity. The disclosure further operates in an unconventional manner by transforming the behavior data of entities of the peer group using random adjustment values, such as LaPlace noise values, to conceal the true data values of those entities from reverse-computation or other deduction methods that other parties may use to obtain those data values. This transformation process is carefully controlled to ensure that a degree of privacy is provided to the entities of the peer group while the accuracy of the transformed data values is preserved to provide an accurate benchmark. The benchmark platform enables efficient generation of benchmarks for a large variety of entities from a centralized data store while protecting the sensitive data of those entities. The benchmark platform enables the regular generation and presentation of benchmarks to many entities in a largely automated way and entities are provided a significant degree of control regarding what types of benchmarks they are provided. The centralized nature of the benchmark platform further enables efficient use of data processing and data storage resources and the accuracy of the generated benchmarks is enhanced based on the capability of the platform to process behavior data from many different entities.

FIG. 1 is a block diagram illustrating a system 100 configured for presenting benchmarks 122 as benchmark visualizations 128 to an entity 106 according to an embodiment. The system 100 includes a data store 102 that stores entity data 108 of multiple entities 106 and a benchmark platform 104 configured to analyze the entity data 108 to generate benchmarks 122 and display visualizations 128 of those benchmarks 122 via a benchmark display interface 126 to the entities 106.

In some examples, the data store 102 and the benchmark platform 104 include hardware, firmware, and/or software configured to store data, analyze data, and to communicate with entities 106 via communication connections (e.g., network connections over the Internet, an intranet, or other network system). The data store 102 and benchmark platform 104 may be stored and/or executed on a computing device such as a server, a personal computer, a laptop, or the like. Alternatively, or additionally, the data store 102 and benchmark platform 104 may be each stored and/or executed on separate computing devices such that they are configured to communicate with each other via a network connection. Further, in some examples, the data store 102 and/or the benchmark platform 104 may be stored and/or executed across multiple computing devices in a distributed way (e.g., via cloud computing techniques) without departing from the description herein.

In some examples, the entities 106 include a plurality of companies that provide data associated with company attributes and behavior within companies as entity data 108. Alternatively, or additionally, the entities 106 may include individual users within companies that provide data associated with user attributes and behavior of users as entity data 108. Further, in other examples, the entities 106 may include other types of entities with behavior that may be compared to other similar entities. It should be understood that, while many examples herein describe functionality associated with entities 106 that are companies, other types of entities may also be used without departing from the description herein.

The entity data 108 that is provided by the entities 106 and stored in the data store 102 includes attribute data 110 for each entity, a peer group threshold 112 for each entity, and behavior data 114. The attribute data 110 of an entity 106 is data that can be used to identify and/or categorize the entity 106. For instance, an entity that is a company may provide attribute data 110 including an indicator of the industry in which the company is involved, a quantity of employees of the company, a geographic location of the company, etc. Alternatively, an entity that is a person within a company may provide attribute data 110 that includes the role of the person within the company, a quantity of other employees that the person manages, a department of the person within the company, or the like. Attribute data 110 may be numerical (e.g., the quantity of employees), categorical (e.g., the industry of the company), or other types of data without departing from the description herein.

The peer group threshold 112 of entity data 108 of an entity 106 describes a minimum required threshold of a quantity of peer entities to which the entity 106 should be compared with generating the benchmarks 122 for the entity 106. For instance, a peer group threshold 112 of a company may be defined as 200 such that, to generate benchmarks 122 for the company, data of the company must be compared to at least 200 other companies. In some examples, a peer group threshold 112 of an entity 106 may be set to a default value upon the entity 106 being registered with the system 100. Such a default value may be defined based on a determined minimum required number of peers to generate statistically accurate benchmarks (e.g., benchmarks based on data of three peer entities may not be useful due to there being too little data, while benchmarks based on data of 50 peer entities may provide useful comparisons). Additionally, or alternatively, a default peer group threshold 112 may be set for an entity based on the attribute data 110 of that entity 106. For instance, the system 100 may have defined peer group thresholds for companies per industry (e.g., software companies may have a default peer group threshold of 25 and pharmaceutical companies may have a peer group threshold of 15) or per employee quantity range (e.g., companies with fewer than 200 employees may have a default peer group threshold of 50 and companies with 1000-2000 employees may have a default peer group threshold of 30). Further, the peer group threshold 112 of an entity 106 may be defined or changed by the entity 106, enabling the entity 106 to control how many peers they are compared to in benchmarks 122. Such custom peer group thresholds 112 may be limited within the system 100 such that they cannot be adjusted below a minimum (as too little data may yield useless benchmarks) and/or above a maximum (as requiring too many peers may prevent benchmarks from ever being generated or otherwise cause the benchmark platform 104 to draw on too broad of a base of peers to the extent that the benchmarks 122 are too general).

The behavior data 114 of an entity 106 includes data that describes behaviors of that entity 106 in categorical, numerical, or otherwise quantifiable forms, such that the behavior data 114 of one entity may be compared to behavior data 114 of other entities. In some examples, where the entity 106 is a person within a company, the behavior data 114 is provided to describe the specific behavior of the person, while in other examples, where the entity 106 is a company, the behavior data 114 is provided to describe behaviors of employees or groups within the company. For instance, behavior data 114 of a company may include collaboration data that describes how employees within the company interact with each other, how and when the employees perform work for the company, how often employees are in meetings, or the like. Alternatively, behavior data 114 of a manager within a company may include data that specifically describes the manager's use of time, interactions with subordinates, or the like. The behavior data 114 may be provided to the system 100 for storage in the data store 102 by the entities 106 via a network connection and, once in the data store 102, the behavior data 114 is used by the benchmark platform 104 to compare peer entities 106 and generate benchmarks 122 as described herein.

In some examples, the behavior data 114 is stored as data values associated with specific data types or categories and/or associated with specific dates and/or times during which the behavior occurred (e.g., a quantity of time spent by employees working on email during a specific day or a quantity of emails sent by employees during a specific day). Alternatively, or additionally, behavior data 114 may be analyzed, aggregated, or combined to form aggregated or combined data values (e.g., a weekly average over six months of a percentage of employees that engaged in collaboration activities after normal business hours for greater than one hour of time). Such aggregated or combined data values may be provided to the data store 102 by the entities 106, they may be calculated upon receiving the unaggregated or uncombined data from the entities 106, or they may be calculated upon the aggregated or combined data values being required by the benchmark platform 104 as described herein or by other applications or entities of the system 100.

The entity data 108 stored on the data store 102 may include data from a wide variety of entities 106 and it may be received or otherwise collected from the entities 106 periodically over time (e.g., once per week), or it may be received according to a pattern defined by the entities 106 themselves (e.g., an entity 106 may send updated entity data 108 to the data store 102 once every three days). Alternatively, or additionally, the entity data 108 may be received or collected at the data store 102 more frequently (e.g., behavior data 114 of an entity 106 may be received by the data store 102 when the associated behavior occurs and is recorded at the entity 106). Other methods or patterns of receiving or otherwise collecting the entity data 108 from the entities 106 may be used without departing from the description.

In some examples, the benchmark platform 104 includes hardware, firmware, and/or software configured to analyze the entity data 108 of entities 106 in order to generate benchmarks 122 and present those benchmarks 122 to entities 106 via benchmark display interface 126 as described herein. The analysis of the entity data 108 includes performance of operations of a peer group selector 116 and a data privacy transformer 118, the generation of the benchmarks 122 includes performance of operations by the benchmark generator 120, and the presentation of the benchmarks 122 may include performance of operations by the benchmark selector 124 and the benchmark display interface 126.

In some examples, the peer group selector 116 is configured to identify, for a target entity (e.g., the entity for which benchmarks 122 are being generated), a peer group 117 of other entities of the entities 106 based on the attribute data 110 and peer group threshold 112 of the target entity. The peer group selector 116 selects entities for the peer group 117 based on those entities having the same or similar attributes as the target entity and so that the quantity of entities in the peer group 117 meets or exceeds the peer group threshold 112 of the target entity. For instance, if a first company entity is in the software industry, has 500-1000 employees, and has a peer group threshold 112 of 50, the peer group selector 116 may search the entity data 108 of the entities 106 to identify all the companies that are in the software industry and also have 500-1000 employees. If the identified set of companies with matching attributes meets or exceeds the threshold 112 of 50 of the first company entity, the identified set of companies is considered the peer group 117 of the first company entity for the purposes of comparison using generated benchmarks as described herein. In other examples, different types of entities may have different types and/or quantities of attributes for comparison and, as a result, the peer group selector 116 may attempt to match entities for a peer group 117 based on some or all of the different attributes of the type of entities (e.g., if a type of entities has four attributes that may be matched, the peer group selector 116 may attempt to fill a peer group 117 of that entity type with entities that match on each of the four attributes). Other rules or criteria may be defined for how the peer group selector 116 matches entities based on the available attributes without departing from the description herein (e.g., matching all entities based on a subset of the available attributes). Attributes of entities may be considered to match if an attribute of a potential peer group entity is within a defined matching scope of the corresponding attribute of the target entity. Such a matching scope may be defined with respect to specific attributes (e.g., a matching scope of a numerical attribute, such as an employee count attribute, may be a range of values that are considered to match, and a matching scope of a categorical attribute, such as an industry category attribute, may be a single industry category or multiple related industry categories).

In some cases, after identifying a set of entities for a peer group 117 based on matching all available attributes, the quantity of the identified entities does not meet the target peer group threshold 112. In such cases, the peer group selector 116 may be configured to expand the matching scope of the attribute to identify additional entities that match closely with the target entity for which the peer group 117 is being selected. The expansion of the scope of the matching process may be done in several ways and the peer group selector 116 may be configured to expand the scope of the matching process based on defined rules or criteria (e.g., defined for a type of entity, for a specific entity, or for a type of attribute data, etc.). For instance, in an example where a peer group 117 of companies is being selected for a first company based on an industry attribute, an employee quantity attribute, and a geographic location attribute, the matching of companies based on all three attributes fails to meet the peer group threshold associated with the first company. The peer group selector 116, in this case, is configured to first expand the scope to include other ranges of the employee quantity attribute while maintaining the scope of the matching for the industry and geographic location attributes (e.g., for an employee quantity attribute of ‘500-1000’, the peer group selector 116 may expand the scope to include a range of ‘1000-2000’ and/or a range of ‘250-500’). The peer group selector 116 then identifies all the matching companies based on the newly expanded employee quantity matching scope and, if the peer group threshold of the first company is met by the identified matching companies, that set of matching companies is considered the peer group 117 of the first company for the generation of benchmarks.

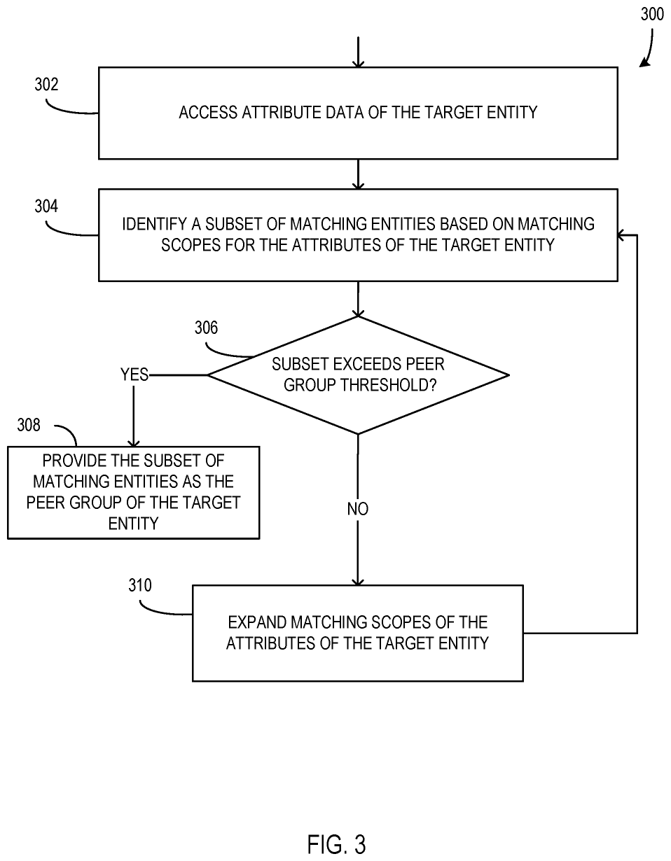

Alternatively, or additionally, if more expansion of the matching scope is needed to reach the peer group threshold of the first company, the peer group selector 116 may be configured to expand the industry attribute matching to include one or more different but related industries (e.g., based on an industry relation table that defines which industries should be used for such expanded matching and in what order the industries should be included in the matching scope). Further, the geographic location attribute matching scope may be similarly expanded if necessary to reach the peer group threshold (e.g., nearby or otherwise similar geographic locations may be considered matches based on a geographic location-based relation table, similar to the table mentioned above with respect to the industry attribute). The peer group selector 116 may be configured to expand the scope of entity matching in a step-by-step process until peer group threshold is reached and then cease the expansion of the scope of entity matching (e.g., first, expand the scope to include one additional employee quantity range, then expand to include a second additional employee quantity range on the other side of the original range, then expand to include one additional geographic location, etc.), such that the scope is reached but a significant level of similarity between the target entity and the entities of the peer group is maintained. The operation of the peer group selector 116 is described further below with respect to FIG. 3.

Additionally, in some examples, the benchmark platform 104 is further configured to enable a user to override the operations of the peer group selector 116 to manually select how attribute data is used to select entities for a peer group and/or to enable a user to adjust or otherwise change attribute data 110 of an entity 106 to ensure that the peer group 117 selected with respect to the entity 106 is accurate based on the user's manual actions. For instance, if a software company is classified under the software industry attribute and a ‘500-1000’ employee count attribute, but a user associated with the software company believes that the company has grown recently and should be classified as having ‘1000-5000’ employees. In such a case, the benchmark platform 104 may be configured to enable the user adjust the employee count attribute or otherwise override the automatic peer group selection as described herein to ensure that the selected peer group fits with the user's understanding of the company.

Once the peer group of entities of a target entity is selected by the peer group selector 116, the benchmark platform 104 obtains the behavior data 114 of each of the entities of the peer group and the behavior data 114 of the target entity for analysis and transformation by the data privacy transformer 118. In some examples, if the behavior data 114 of the target entity and each of the entities of the peer group have not been aggregated, combined, and/or transformed into data that will be used in the generation of benchmarks by the benchmark generator 120, such aggregation, combination, or transformation may be performed by the benchmark platform 104 prior to and/or after transformation of the behavior data 114 by the data privacy transformer 118 as described herein. For instance, behavior data 114 including data values that indicate weekly time spent working with emails for each employee may be transformed into data values that indicate an average percentage of employees that spend 10 or more hours per week on email over six months). Such calculations may be done based on a defined set of metrics for which benchmarks are generated by the benchmark generator 120. The set of metrics may be defined as default metrics of the system 100 and/or custom metrics requested by one or more of the entities 106 that makes use of the system 100.

In some examples, the data privacy transformer 118 includes hardware, firmware, and/or software configured to apply adjustments to the behavior data 114 of the entities 106 in order to prevent an entity or entities from determining specific behavior data of specific entities based on presented benchmarks 122. For instance, in an example where there are 100 companies for which benchmarks are generated and provided that include behavior data value averages and/or aggregates of all 100 companies. If 99 of the companies cooperated to combine their own data, they would be able to determine the behavior data values of the 100^{th} company without that company's permission. If the exact data values of behavior data 114 of entities 106 is used in the benchmarks, those benchmarks may represent significant weak points through which others with access to the benchmarks may obtain sensitive behavior data that the entities 106 would otherwise keep secret. Thus, the data privacy transformer 118 is configured to apply a differential privacy transformation process to the behavior data 114 to conceal the actual data values of the behavior data 114 and still enable the benchmark generator 120 to generate accurate benchmarks 122.

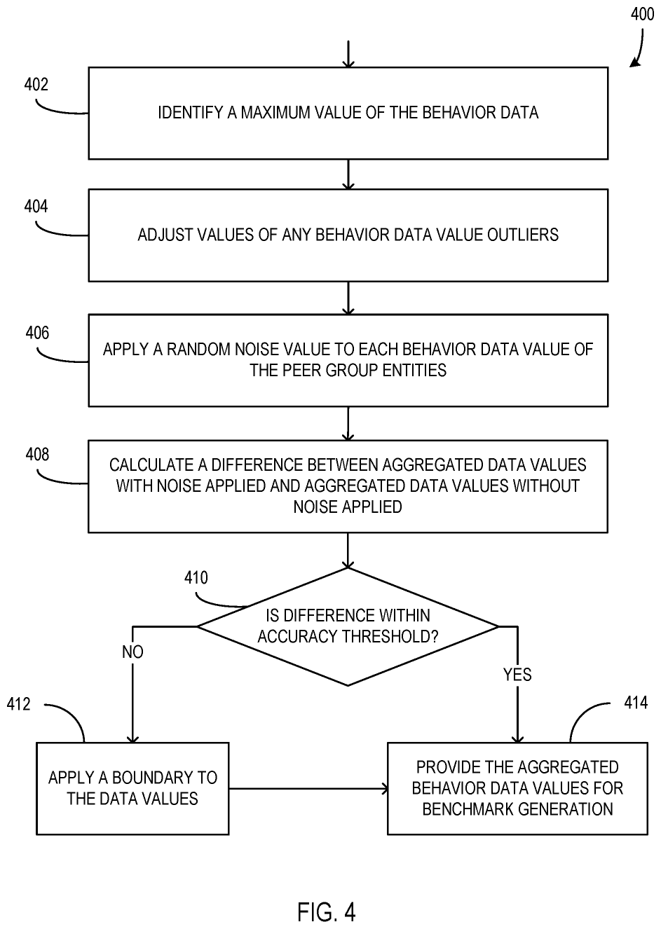

In some examples, the transformation process includes, for each aggregated behavior data value that is used to generate a benchmark, applying randomly generated adjustment values to the raw behavior data values from which the aggregated behavior data value will be generated (e.g., using LaPlace noise values as described below with respect to FIG. 4), adjusting for any outlier adjusted behavior data values based on a defined value maximum (e.g., reducing adjusted behavior data values to the defined value maximum if they are adjusted to be greater than the value maximum), and calculating the aggregated or combined behavior data value that will be used in the benchmarks (e.g., aggregated or average values of raw behavior data values as described above). Then, the aggregated behavior data value based on the adjusted behavior data values is compared to an aggregated behavior data value based on the non-adjusted, raw behavior data values and, if the difference between the two aggregated behavior data values is less than or equal to a defined threshold, the transformation is considered complete and sufficiently accurate and the aggregated behavior data values based on the adjusted behavior data values are used to generate a benchmark 122 as described herein. Alternatively, if the result is greater than the defined threshold, the aggregated data value based on the adjusted behavior data values is capped such that the difference between the aggregated behavior data value based on the non-adjusted, raw behavior data values is equal to the defined threshold. This transformation process is described in greater detail below with respect to FIG. 4.

In some examples, the benchmark generator 120 includes hardware, firmware, and/or software configured to use behavior data 114 and/or related transformed and/or aggregated behavior data (e.g., the aggregated behavior data values based on adjusted behavior data values from the data privacy transformer 118 as described above) of a peer group of entities to generate benchmarks 122 (e.g., data objects and/or other types of data structures that are populated with data associated with a type of behavior data for comparing that type of behavior data of the entities in a peer group with that type of behavior data of a target entity associated with the peer group). Generating a benchmark 122 may include using the functionality of the data privacy transformer 118 to transform the behavior data of the entities in the peer group as described herein to prevent sensitive behavior data of one entity from being revealed to other entities in the peer group or to the target entity of the benchmark 122.

For instance, if a benchmark 122 intended for a target company entity and based on a peer group of the target company entity is being generated in association with a metric of “average time spent by employees on email weekly” and the benchmark 122 is being generated based on the past six months-worth of behavior data, the benchmark generator 120 may be configured to access behavior data 114 of each entity in the peer group and the target entity associated with the time spent by employees on email over the past six months. The behavior data of the peer group may be provided to the data privacy transformer 118 and the resulting aggregated behavior data values based on adjusted behavior data values may be obtained from the data privacy transformer 118 for use by the benchmark generator 120. In some cases, the benchmark generator 120 does not provide the behavior data 114 of the target entity to the data privacy transformer 118 as the target entity has access to its own untransformed behavior data 114. Alternatively, the benchmark generator 120 may be configured to send the behavior data 114 of the target entity to the data privacy transformer 118 as with the behavior data of the entities of the peer group. In some examples where the target entity's behavior data 114 is not sent to the data privacy transformer 118, the benchmark generator 120 is configured to transform the raw behavior data 114 of the target entity into an aggregated behavior data value such that it can be compared to the aggregated behavior data values associated with the peer group that are received from the data privacy transformer.

It should be understood that, in other examples where the data privacy transformer 118 is not used to transform behavior data 114, the benchmark generator 120 may be configured to generate any aggregated behavior data values that are to be compared in a benchmark 122 from the behavior data 114 of the entities of the peer group and of the target entity. Some exemplary behavior categories, behaviors, and associated benchmark metrics that may be associated with company entities are provided in Table 1 below:

TABLE 1

| Category | Behavior | Metrics | Calculation for each entity |
|---|---|---|---|
| Employee | Balance/ | After hours | Weekly Average over 6 months |
| Experience | Wellbeing | collaboration | (100*Count of employees who |
| | | hours | have after hours collaboration |
| | | | greater than 1 hour/total |
| | | | measured employees in |
| | | | the company) |
| | Employee | Diverse ties | Monthly Average over 6 months |
| | Connected- | (network breadth) | (100*Count of employees who |
| | ness | | have <3 diverse ties/total |
| | | | measured employees) |
| | Email | Email hours | Weekly average over 6 months |
| | | | (100*Count of employees who |
| | | | have greater than 10 email hours/ |
| | | | total measured employees in |
| | | | the company) |
| | Manager | Meetings with | Weekly average over 6 months |
| | coaching | manager 1:1 | (100*Count of employees who have |
| | | | less than 15 minutes of 1:1 time with |
| | | | managers/total measured employees |
| | | | in the company) |
| Organizational | Meetings | Meeting hours | Weekly average over 6 months |
| Agility | | Customization | (100*Count 1 if (Meeting hours in |
| | | of meeting | long or large meetings/Meeting |
| | | hours for long | hours per person >0.5)/Total |
| | | or large meetings | measured employees in the |
| | | | company) |
| | | | Long is greater than 1 hour |
| | | | Large is more than 8 attendees |
| | Focus | Total focus | Weekly average over the past 6 |
| | | hours (And its | months (100*(Count of measured |
| | | equivalent | employees who have less than 20 |
| | | Nova name) | hours of focus time during the |
| | | | week/Total measured employees)) |
| | Influence | Influence - ONA | Weekly Average over 6 months |
| | | | (100*Weekly Count of employees |
| | | | who are in the network of the |
| | | | influencers [do not double count]/ |
| | | | Count of measured employees) |
| | Manager | Internal network | Weekly average over 6 months |
| | Connected- | breadth | (100*Count of managers who |
| | ness | | have network breadth less than 6/ |
| | | | total measured managers in the |
| | | | company) |
| | Teams | 1:1 IMs and 1:1 | Weekly average over 6 months |
| | | email | (100*Count of managers who |
| | | | have send less than 10% of their |
| | | | 1:1 communication via IMs/ |
| | | | total measured managers in the |
| | | | company) |
| Customer | External: | External | Weekly average over 6 months |
| Focus | time | collaboration | (100*count of employees with |
| | | hours | external network size >3/count of |
| | | | all measured employees) |
| | External: | External | Monthly average over 6 months |
| | people | network size | (100*Count of employees with |
| | | Networking | (external network size/network |
| | | outside | size outside the company)greater |
| | | company | than 1.5/Count of all measured |
| | | (External | employees) |
| | | network | |
| | | breadth) | |

After the benchmark generator 120 has the aggregated behavior data values to be compared in the benchmark 122 from the entities of the peer group and from the target entity, the benchmark generator 120 may be configured to analyze the aggregated behavior data values to identify a range of data values (e.g., the range of aggregated behavior data values from lowest to highest) and/or a distribution of data values (e.g., quantities of entities that are associated with specific data values within the range and/or with specific subranges of data values within the range). The aggregated behavior data values and the associated range of the data values and/or the distribution of the data values may be included in the benchmark 122 being generated (with any identifying information removed from the data values associated with entities of the peer group).

Further, the benchmark generator 120 may be configured to calculate percentile data based on the distribution of the data values to determine which data values represent percentiles of the range of data values (e.g., a 25^{th} percentile, a 50^{th} percentile, and/or a 75^{th} percentile may be calculated for the distribution of the data values). For instance, calculating a 25^{th} percentile may include organizing the data values in order from lowest to highest, calculating a number equal to 25% of the total quantity of data values, and counting up the organized data values from the lowest data value to the data value that is the calculated number from the lowest data value, wherein that data value is the 25^{th} percentile data value of the set of data values. Additionally, similar calculations may be done to determine a percentile value of the data value of the target entity. Such percentile data may also be included in the benchmark 122 being generated.

In some examples, the benchmark generator 120 is further configured to generate and/or include other data in generated benchmarks 122, including any other types of data that are described as being part of the benchmarks 122 herein, without departing from the description.

Additionally, in some examples, the benchmark platform 104 and/or the benchmark generator 120 are configured to generate benchmarks 122 associated with one or more entities 106 repeatedly and/or on a periodic basis. For instance, the benchmarks 122 may be regenerated or otherwise updated by the benchmark generator 120 every month, every quarter, or based on another length of period. Alternatively, or additionally, the benchmark platform 104 and/or benchmark generator 120 may be configured to regenerate or otherwise update benchmarks 122 based on other triggers, events, or the like, such as updating a benchmark 122 when the entity data 108 used to generate the benchmark 122 is updated in the data store 102 or when a user requests for the benchmark 122 to be regenerated or updated.

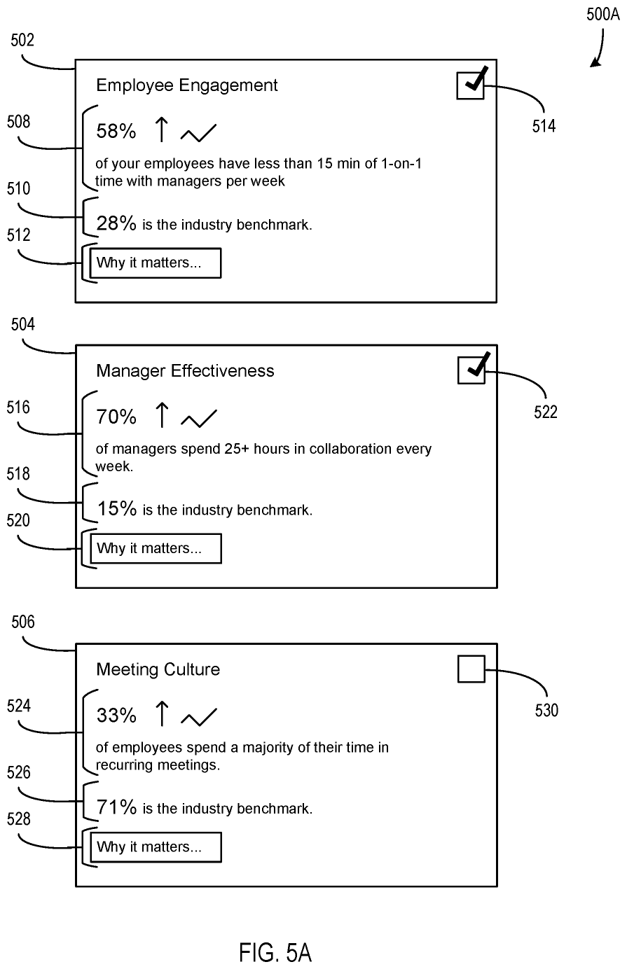

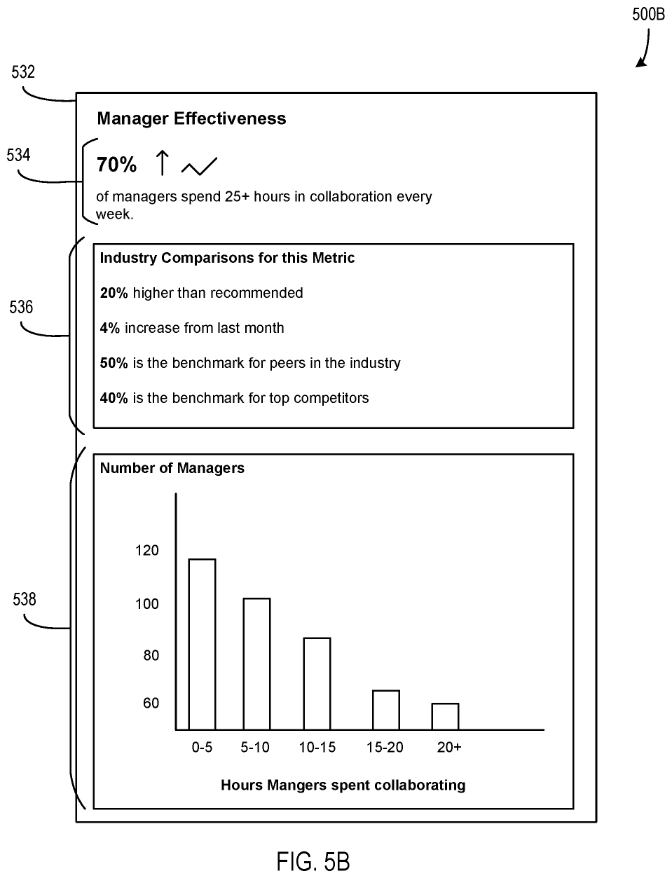

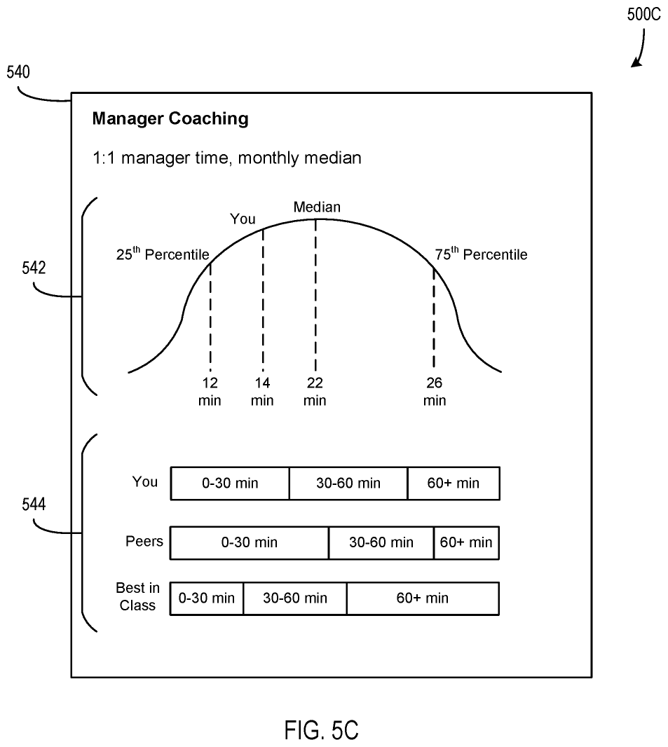

In some examples, the benchmarks 122 generated by the benchmark generator 120 are configured as data objects or other data structures that include behavior data values (e.g., the aggregated behavior data values generated by the data privacy transformer 118 and/or the benchmark generator 120) associated with specific types of behavior and associated data based on analysis of those behavior data values (e.g., data values range, data value distribution, percentile data, or the like). Each benchmark 122 may include data associated with a specific metric of behavior and, in addition to numerical data and/or analysis-based data, a benchmark 122 may include text data that can be used to identify and/or describe the behavior metric being benchmarked. Further text data and/or other associated data may be included in the benchmark 122 that describes the current performance of the target entity with respect to the entities of the peer group based on the comparison of the data value of the target entity to the data values of the peer group as described herein. Such text data may further be based on the specific type of behavior metric being benchmarked, such that the text data may include descriptions of action items and other recommendations for improving performance that are specific to the type of behavior being benchmarked. Such text data may be obtained from predefined sets of text data (e.g., a data store may include predefined text data associated with each specific behavior metric and/or associated with combinations of specific behavior metrics and target entity percentiles within the benchmarks). Exemplary features of benchmarks 122 are described further below with respect to FIGS. 5A-C.

In some examples, the benchmark selector 124 includes hardware, firmware, and/or software configured to select one or more benchmarks 122 to be presented to the target entity. The selection of the one or more benchmarks 122 may be based on behavior category settings defined by the target entity, based on the performance of the target entity in the various benchmarks 122, and/or based on other settings defined for selecting benchmarks 122 to be presented. For instance, in examples where the target entity is a company, the company may define a set of behavior categories or specific benchmarks (e.g., some behavior categories may be associated with multiple specific benchmarks, such as an “employee experience” behavior category that includes benchmarks associated with work life balance, employee connectedness, email behaviors, and/or management or coaching behaviors) that should be presented to the company by the system 100 as described herein. The benchmark selector 124 is configured to identify the required behavior categories and/or specific benchmarks 122 as defined by the company and present those specific benchmarks 122 and/or benchmarks 122 associated with the required behavior categories to the company.

Additionally, or alternatively, the benchmark selector 124 may be configured to select benchmarks 122 for a target entity based on the target entity's performance in the benchmarks relative to the peer group. For instance, the benchmark selector 124 may be configured with rules or settings to select a subset of benchmarks 122 in which the target entity performs the poorest when compared to the peer group, such that the target entity is presented with information about areas where significant improvement is possible and/or needed. Further, the benchmark selector 124 may be configured with rules or settings to select a subset of benchmarks 122 in which the target entity performs the best when compared to the peer group, such that the target entity is presented with information about areas where they are doing well relative to the peer group. In some examples, such configuration rules or settings may be combined such that the benchmark selector 124 is configured to select both benchmarks 122 where the target entity is performing well and where the target entity is performing poorly. Further, the benchmark selector 124 may be configured to select more, fewer, or different subsets of benchmarks 122 for presentation based on the target entity's relative performance without departing from the description.

In some examples, the benchmark selector 124 may be configured to select a subset of benchmarks 122 for presentation to the target entity based on changes in the behavior data and/or the relative performance of the target entity with respect to the selected benchmarks 122. For instance, if the benchmark selector 124 determines that the behavior data values and/or the relative performance of the target entity have fallen with respect to a benchmark 122 since a previous time that the benchmark 122 was generated, the benchmark selector 124 may be configured to select that benchmark for presentation to the target entity, whereby the target entity is notified of behaviors that may need attention due to falling performance. Alternatively, or additionally, the benchmark selector 124 may be configured to select benchmarks 122 based on determining that the behavior data values and/or the relative performance of the target entity has improved since a previous time that the benchmark 122 was generated, whereby the target entity is notified of behaviors in which there has been improvement. The benchmark selector 124 may be configured to only select such benchmarks 122 when the change in behavior data values and/or relative performance meets or exceeds a defined threshold (e.g., the benchmark selector 124 selects benchmarks 122 when a change of 10 or more percentile points is identified between a previous instance of the benchmark 122 and the current instance of the benchmark 122).

It should be understood that, in other examples, the benchmark selector 124 may be configured to select benchmarks 122 for presentation based on more, fewer, or different settings or rules and/or based on definitions provided by target entities without departing from the description herein.

In some examples, the benchmark display interface 126 includes hardware, firmware, and/or software configured for displaying, presenting, or otherwise providing data of benchmarks 122 as benchmark visualizations 128 to a target entity. The benchmarks 122 that are presented as benchmark visualizations 128 by the benchmark display interface 126 may be the benchmarks 122 that have been selected for presentation by the benchmark selector 124 as described herein. The benchmark display interface 126 may be configured to present benchmarks 122 as benchmark visualizations 128 by transforming the data included in the benchmarks 122 (e.g., the aggregate behavior data values, ranges of data values, distributions of data values, percentile data, etc.) into a format and/or pattern that may be displayed in such a way that it may be viewed by the target entity and/or users associated with the target entity. For instance, in some examples, the benchmark display interface 126 is configured to send data to the target entity that enables the target entity to display a benchmark platform visualization on a screen or other visual-based user interface. The data sent by the benchmark display interface 126 further enables the target entity to populate the benchmark platform visualization with one or more specific benchmark visualizations 128 as selected by the benchmark selector 124. The presentation of the benchmark visualizations 128 by the benchmark display interface 126 may further include determining the order and/or pattern in which the benchmark visualizations 128 are displayed to the target entity if there are more than one benchmark visualization being displayed.

In some examples, presenting a benchmark visualization 128 by the benchmark display interface 126 further includes arranging text and numerical data of the associated benchmark 122 according to a defined pattern and/or arranging visual representations (e.g., graphs of change in the behavior data values over time, bell curve visualizations illustrating the percentile data of the peer group behavior data and the placement of the target entity on the bell curve) of the data of the benchmark 122 according to the defined pattern. The patterns and arrangements of data used by the benchmark display interface 126 to present benchmark visualizations 128 is described further below with respect to FIGS. 5A-C.

In some examples, the benchmark platform 104 is configured to generate benchmarks 122 for each entity 106 that is registered to receive or has otherwise requested benchmarks 122 based on a defined schedule. For instance, the platform 104 may generate new benchmarks 122 every month, every three months, every six months, or the like. Alternatively, or additionally, the benchmark platform 104 may be configured to generate new benchmarks 122 based on schedules set specifically by individual entities (e.g., benchmarks 122 may be generated every three months for a first entity and every month for a second entity). Further, the benchmark platform 104 may be configured to generate new benchmarks 122 when requested by entities 106 and/or when a defined portion of new behavior data has been received. Other configurations for the schedule of generating new benchmarks 122 by the benchmark platform 104 may be used without departing from the description.

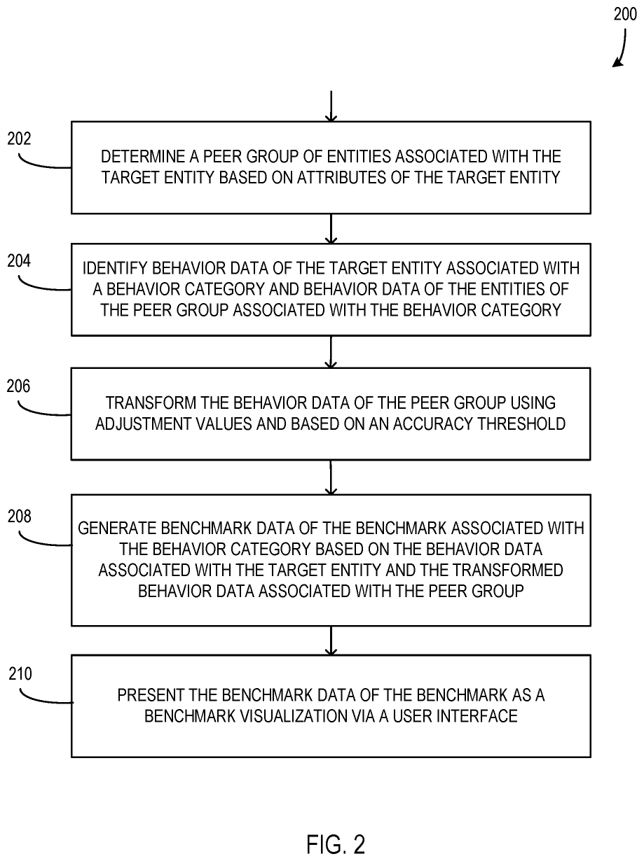

FIG. 2 is a flowchart illustrating a computerized method 200 for presenting benchmarks (e.g., benchmarks 122) as benchmark visualizations (e.g., benchmark visualizations 128) to an entity (e.g., entity 106) according to an embodiment. In some examples, the method 200 is executed and/or otherwise performed by one or more components of a system such as system 100. For instance, the method 200 may be performed by a benchmark platform such as benchmark platform 104 as described herein. At 202, a peer group of entities are determined that are associated with the target entity based on attributes of the target entity. In some examples, determining entities for the peer group includes matching the attributes of the target entity to entities that are being considered for inclusion in the peer group and, based on an entity including attributes that match the attributes of the target entity, the entity may be included in the peer group. Matching of an attribute of an entity to the corresponding attribute of the target entity may be based on a defined matching scope associated with that attribute (e.g., a numerical attribute may be considered to match if it is within a matching scope of a defined range of values in which the attribute value of the target entity is present, while a categorical attribute may be considered a match if it is within a matching scope of a defined set of related categories of the attribute value of the target entity). The determination of the peer group of entities is described in greater detail below with respect to FIG. 3.

At 204, behavior data of the target entity associated with a behavior category and behavior data of the entities of the peer group associated with the behavior category are identified. In some examples, the behavior data of the target entity and the entities of the peer group are accessed from entity data (e.g., entity data 108) in a data store (e.g., data store 102). The identified behavior data may include data that reflect or describe behavior of or associated with each of the corresponding entities, such as data values that measure an aspect of the behavior at a current point and/or over a period of time. Further, the behavior data may include aggregated or combined data values that are based on an aggregation, averaging, or other combination of multiple data values of the corresponding entities (e.g., the weekly average value of a behavior data value of an entity over the last six months). In such cases, identifying the behavior data as described herein may include performance of aggregation, averaging, or other data combination processes to obtain those data values without departing from the description.

At 206, the behavior data of the entities of the peer group are transformed using adjustment values and based on an accuracy threshold. The adjustment of the behavior data values of the entities of the peer group provides privacy protections of the sensitive behavior data of each entity by concealing the precise behavior data values. The adjustment values applied to each behavior data value may be randomly generated and of varying sizes. Further, an adjustment value may be either positive, such that the adjusted behavior data value is increased, or negative, such that the adjusted behavior data value is decreased. The transformation of the behavior data is also based on an accuracy threshold that is used to limit the degree to which the behavior data is adjusted in order to maintain the accuracy of the generated benchmarks. For instance, the behavior data of an entity should be changed only to a defined degree such that the resulting aggregated or combined data values used in the benchmark are sufficiently close to the corresponding aggregated or combined data values that are based on behavior data values that have not been adjusted. The transformation process of 206 is described in greater detail below with respect to FIG. 4.

At 208, benchmark data of the benchmark associated with the behavior category is generated based on the behavior data associated with the target entity and the entities of the peer group. In some examples, generation of the benchmark includes aggregating, averaging, or otherwise combining behavior data values of the entities into aggregated behavior data values that are then compared to generate benchmark data. Generating benchmark data may further include calculating ranges, distributions, and/or percentile data of the behavior data values and/or aggregated behavior data values of the entities as described herein. Additionally, or alternatively, benchmark data may performance data indicating the relative performance of the target entity with respect to the entities of the peer group with respect to the behavior category of the benchmark. Such performance data may include current performance data such as a percentile value of the target entity's behavior with respect to the behavior of the peer group and/or “rate of change” performance data of the target entity indicating the degree to which the target entity's performance of the behavior has changed over time (e.g., the change in percentile value of the target entity over time relative to the behavior of the entities of the peer group). In other examples, more, fewer, or different types of benchmark data may be generated without departing from the description.

At 210, the benchmark data of the benchmark is presented as a benchmark visualization via a user interface. In some examples, presenting the benchmark data as a benchmark visualization includes presenting numerical representations of the behavior data of the target entity and the entities of the peer group in a manner that enables a viewer to compare them. Additionally, or alternatively, graphical representations of the behavior data, such as charts, graphs, or other visualizations, may be presented to the user. In some examples, presenting the benchmark data further includes selecting multiple benchmarks for presentation and presenting the benchmark data from the selected multiple benchmarks as described herein. Selection of benchmarks for presentation may be based on defined settings or rules as established by the target entity and/or the selection may be based on the relative performance of the target entity in the benchmarks or changes in the relative performance of the target entity meeting or exceeding thresholds as described herein.

FIG. 3 is a flowchart illustrating a computerized method 300 for determining a peer group (e.g., peer group 117) of a target entity (e.g., entity 106) for use in generating benchmarks (e.g., benchmarks 122) according to an embodiment. In some examples, the method 300 is executed and/or otherwise performed by one or more components of a system such as system 100. For instance, the method 300 may be performed by a benchmark platform and/or associated components such as benchmark platform 104 and/or a peer group selector 116 as described herein. At 302, attribute data of the target entity is accessed and, at 304, a subset of matching entities are identified based on matching scopes for the attributes of the target entity. If, at 306, the identified subset of entities exceeds the peer group threshold of the target entity, the process proceeds to 308. Alternatively, if the identified subset of entities does not exceed the peer group threshold of the target entity, the process proceeds to 310. In some examples, identifying the subset of matching entities includes comparing attribute values of each attribute of the target entity to attribute values of corresponding attributes of each other entity and, if the attribute values of an entity all are considered to match the corresponding attribute values of the target entity based on matching scopes of those attributes, the entity is considered to be a matching entity of the target entity. Each entity may be evaluated in this way. It should be understood that the first time the subset of matching entities is identified at 304 in the method 300, the attributes and associated matching scopes used may be based on a default set of attributes and default set of matching scopes. As described herein, the process may expand matching scopes and/or removing attributes from being used for matching at 310 as the subset of matching entities is identified as described herein.

At 308, the subset of matching entities is provided as the peer group for the target entity. In some examples, this peer group is used to generate benchmarks for presenting to the target entity as described herein.

At 310, the matching scopes of the attributes of the target entity are expanded and process returns to 304 to identify additional matching entities for inclusion in the subset. In some examples, the matching scopes of the attributes may be expanded in a variety of ways, as described herein. Further, the matching scopes may be expanded at 310 multiple times prior to a full peer group of entities being identified and different matching scopes may be expanded each time according to defined settings or rules configured for expanding matching scopes. For instance, a first time that the matching scopes are expanded at 310, a matching scope of one attribute may be expanded and, later, the second time that matching scopes are expanded at 310, the matching scope of a different attribute may be expanded. Each time a matching scope of an attribute or matching scopes of multiple attributes are expanded, the process returns to 304 to and the subset of identified matching entities may be expanded to include additional entities that now match the target entity based on the expanded matching scope. Alternatively, or additionally, expanding matching scopes of attributes of the target entity may include one or more attributes of the target entity not being used for matching (e.g., rather than matching entities based on two attributes, entities are matched based on a first attribute and the second attribute is no longer used for matching).

Some examples of expanding matching scopes for attributes of entities that are companies include expanding a matching range of an employee count attribute, expanding the categories that are considered to match an industry category attribute, and/or expanding the categories that are considered to match a geographic location category attribute.

FIG. 4 is a flow chart illustrating a computerized method 400 for adjusting behavior data (e.g., behavior data 114) of entities (e.g., entities 106) in a peer group (e.g., peer group 117) to enhance privacy with respect to associated benchmarks (e.g., benchmarks 122) according to an embodiment. In some examples, the method 400 is executed and/or otherwise performed by one or more components of a system such as system 100. For instance, the method 400 may be performed by a benchmark platform and/or associated components such as benchmark platform 104 and/or a data privacy transformer 118 as described herein. At 402, a theoretical maximum value of the behavior data is identified. In some examples, the method 400 includes generating LaPlace noise values as the random noise values for adjusting behavior data values and, to make use of the LaPlace noise techniques described herein, a maximum value of the metric is determined or otherwise identified at 402. In some such examples, the maximum value ‘M’ may be determined by selecting the lowest value of: a theoretical maximum of behavior data values of the metric, a 95^{th} percentile data value multiplied by 1.1, or a 90^{th} percentile data value multiplied by 1.25. In other examples, other methods of identifying a maximum value ‘M’ may be used without departing from the description.

At 404, behavior data value outliers are adjusted. In some examples, the behavior data values that are to be transformed are compared to the maximum value ‘M’ identified at 402 and values that exceed ‘M’ are restricted to ‘M’ prior to applying the random adjustments described below at 406.

At 406, a random noise value is applied to each behavior data value of the peer group entities. In some examples, LaPlace noise values randomly generated and added to or subtracted from each behavior data value of the peer group entities. A probability distribution for a LaPlace function is defined by the below equation:

$$f ( x \vert μ , b ) = \frac{1}{2 b} exp ( - \frac{\vert x - μ \vert}{b} )$$

In this equation, μ is a location parameter and b, which is sometimes referred to as the diversity, is a scale parameter. For instance, if μ=0 and b=1, the positive half of the function is exactly an exponential distribution scaled by ½. In the case of generating LaPlace noise values, μ is set to zero and b is set to

$$\frac{M}{ɛ} ,$$

such that a shorthand for the function may be written as LaPlace

$$( 0 , \frac{M}{ɛ} ) .$$

M is set to the maximum value identified at 402 and ε is a value that can be defined at various values based on a tradeoff between privacy of the result and accuracy of the result (e.g., a more accurate result may have be less secure from a privacy standpoint due to smaller changes being made using the LaPlace noise values). In such examples, the random LaPlace noise values generating using the described equation are generated based on these defined values.

At 408, a difference between aggregated data values with noise applied and aggregated data values without noise applied is calculated. If the difference is not within an accuracy threshold at 410, the process proceeds to 412. Alternatively, if the difference is within the accuracy threshold at 410, the process proceeds to 414. In some examples, where the LaPlace noise values described above are used to adjust the behavior data values, the accuracy of the results are enforced by comparing an aggregated or average value of the behavior data values that have been adjusted by LaPlace noise values, ‘Average Value After Noise’, and an aggregated or average value of the behavior data values that have not been adjusted, ‘True Value’. This difference is compared to a defined accuracy threshold associated with the previously identified maximum value, ‘M’ (e.g., 10% of ‘M’). If the difference is greater than the accuracy threshold, the process proceeds to 412. Otherwise, the process proceeds to 414. This comparison may be represented by the following equation:

|AverageValueAfterNoise−TrueValue|≤10%*M

At 412, a boundary is applied to the aggregated data values associated with the applied noise values to bring them within the boundary. In examples in which LaPlace noise values are used as described herein, the boundary is set based on the accuracy threshold (e.g., 10% of ‘M’), such that the ‘Average Value After Noise’ is adjusted to be within the boundary. The adjustment may increase an ‘Average Value After Noise’ that is less than the corresponding ‘True Value’ and/or it may decrease an ‘Average Value After Noise’ that is greater than the corresponding ‘True Value’. For instance, if ‘M’ is 10, the accuracy threshold is 1, the ‘True Value’ is 6, and the ‘Average Value After Noise’ is 7.5, the ‘Average Value After Noise’ is more than 1 (the accuracy threshold) larger than the ‘True Value’ and is adjusted down to 7 from 7.5 to be within the accuracy threshold.

At 414, the aggregated behavior data values associated with the applied noise values are provided for benchmark generation. In some examples, the aggregated behavior data values are provided by the data privacy transformer 118 to the benchmark generator 120 as described herein.

In examples in which the LaPlace noise techniques are used, an expected privacy guarantee may be calculated using e^{(α*ε)}, where α is a “range to protect”, referring to the range at which reverse-computing or otherwise deducing the adjusted behavior data value is considered safe. For instance, if the range of the behavior data value may be 0-40, α is set to ⅛, and the true value is zero, then it is considered safe, or sufficiently secure, if efforts to deduce the true value yield five instead of zero (e.g., 40*⅛=5). This expected privacy guarantee is a worst-case guarantee. The guarantee refers to a case where a person trying to deduce a data value knows all other values other than the targeted value. If there were 10 total values, the person is assumed to know 9 of the values and to be deducing the 10^{th} value.

In some examples in which the LaPlace noise techniques described herein are used, the variables of the equations used may be adjusted to increase the accuracy of the result and/or increase the security or privacy provided. It should be understood that the configuration of such variables may be done in any way without departing from the description. Some considerations for determining such variables includes calculating the probability that adjusted values will fall outside the accuracy threshold and attempting to minimize or at least reduce that probability. Further, a potential quantity of tries for a behavior may be considered (e.g., a particular set of behavior data may be analyzed with more than one subsets or slices of entities in a peer group, which may give additional information for use in deducing real values from the results).

Additionally, or alternatively, in examples in which the benchmark metric being used is not based on an aggregated or average value of many data values but instead based on a threshold metric (the benchmark metric is the quantity, percentage, or proportion of people or other entities that are above/below a defined threshold), other techniques may be used to provide privacy and security of behavior data values while still providing accurate benchmark data. For instance, prior to generating a benchmark, the behavior data values of the entities of the peer group may be transformed by applying a function that changes an indicator or flips a bit that indicated whether a behavior data value is above or below the defined threshold based on a defined probability function. Alternatively, or additionally, the threshold itself may be adjusted in a random way (e.g., using a LaPlace function to introduce uncertainty) when determining how many behavior data values are above/below the threshold.

It should be understood that, in other examples, more, fewer, or different types of techniques may be used to introduce randomness and/or increase privacy or security of the peer group behavior data without departing from the description herein.

FIGS. 5A-C are diagrams illustrating exemplary graphical user interfaces (GUIs) 500A, 500B, and 500C for displaying benchmark visualizations (e.g., benchmark visualizations 128) according to an embodiment. In some examples, The GUIs 500A, 500B, and 500C are displayed or otherwise presented to an entity that is a company by a system such as system 100 and/or associated components such as the benchmark display interface 126.

In FIG. 5A, three exemplary benchmark visualizations 502, 504, and 506 are illustrated. In some examples, a user at a company may be presented with one or more of the visualizations 502-506 at one time. The Employee Engagement visualization 502 includes a portion 508 that presents a current performance metric of the company, including a direction in which the performance metric is changing (the up arrow) and/or a graph illustrating the change of the performance metric, as well as text that describes what the performance metric indicates. The visualization 502 further includes portion 510 including a peer group performance metric and a portion 512 that includes a button or other activatable interface component that enables a viewer to request additional context or information about the benchmark being displayed. In some examples, the visualizations 502-506 may be presented with checkboxes 514, 522, and 530 or other similar interface components when the viewer is being prompted to select which benchmarks they want to see in the future. By checking or otherwise activating the checkboxes 514 and 522 and not checking or otherwise activating the checkbox 530 as illustrated, the user may select to be presented the visualizations 502 and 504 in the future and to not be presented the visualization 506 in the future.

The benchmark visualizations 504 and 506 each include corresponding portions to the portions of the visualization 502 as described above. Each of the visualizations 504 and 506 has respective portions 516 and 524 that display information about the performance of the target company entity with respect to the associated behaviors (e.g., Manager Effectiveness, Meeting Culture). Each of the visualizations 504 and 506 has respective portions 518 and 526 that display peer group performance information for comparison to the performance of the target company entity, and each has respective portions 520 and 528 that include buttons or other activatable interface components that enables a viewer to request additional context or information about the benchmark being displayed. Interacting with portions 512, 520, and/or 528 may cause more information about the behavior associated with the benchmark, such as insights or other recommendations for how to improve the behavior going forward and/or potential effects of having high or low levels of performance in the behavior.

FIG. 5B illustrates a GUI 500B including a benchmark visualization 532. The visualization 532 displays or otherwise presents behavior data and/or benchmark data associated with a “Manager Effectiveness” behavior category. The portion 534 presents data describing performance of the target company entity with respect to a particular metric: the percentage of managers that sped 25+ hours in collaboration every week. In this case, the percentage is 70%. Further, as described above, the portion 534 displays graphical representations of how the performance by the target company entity has changed over time (e.g., the up arrow and the graph line). The visualization 532 further includes a portion that presents a series of comparisons to other companies in the industry (e.g., the company entities in the peer group of the target company entity) associated with the behavior category and the performance of the target company entity in that behavior category. In this case, the portion 536 shows that the target company entity is 20% higher than recommended regarding the described performance metric and that it has increased 4% from last month. Further, the portion 536 shows that the benchmark or median level of performance for peers is 50% and that the benchmark or medial level of performance for top competitors, or “best-in-class” peers from the peer group, is 40%. This information may be viewed and may provide a user at the target company entity with information that may be useful in determining a course of action with respect to the described behavior category. Additionally, the visualization 532 includes a portion 538 that presents a bar graph illustrating the relationship between the number of managers of a company with the number of hours spent collaborating on average. It should be understood that, in other examples, more, fewer, or other types of visualizations, graphs, charts, or the like may be presented within the visualization 532 without departing from the description.

FIG. 5C illustrates a GUI 500C including a benchmark visualization 540. The visualization 540 displays or otherwise presents behavior data and/or benchmark data associated with a “Manager Coaching” behavior category. The portion 542 presents a bell curve visualization that illustrates a distribution of the behavior data of the peer group, including a median value indicator, a 25^{th} percentile indicator, and a 75^{th} percentile indicator. Further, the behavior data associated with the target entity, marked “You” and showing a 14 minute data value that lies between the 25^{th} percentile value of 12 minutes and the median value of 22 minutes, is shown on the bell curve, enabling a viewer to visually compare the performance of the target entity with the performance of the peer group.

Additionally, the benchmark visualization 544 presents a series of bars associated with the target entity, labeled “You”, the peer group, labeled “Peers”, and a subset of the highest performing peers in the peer group, labeled “Best in Class”. Each of the bars presents a breakdown of proportions of managers that provide various ranges of one-on-one coaching time (e.g., 0-30 minutes, 30-60 minutes, and 60+ minutes). This information is presented by dividing a bar representing the total set of managers into proportionally sized parts of the bar, so a viewer can quickly see how managers' efforts at one-on-one coaching are divided for each bar. The “Best in Class” subset of peers may be selected based on a defined setting or rule, such as selecting the top 25% of peers in this behavior category or selecting the top ten peers in this behavior category. Other methods of selecting a “Best in Class” subset may be used without departing from the description. Further, Other types of graphs or other visualizations may be configured to include information about a “Best in Class” subset without departing from the description.

### Exemplary Operating Environment

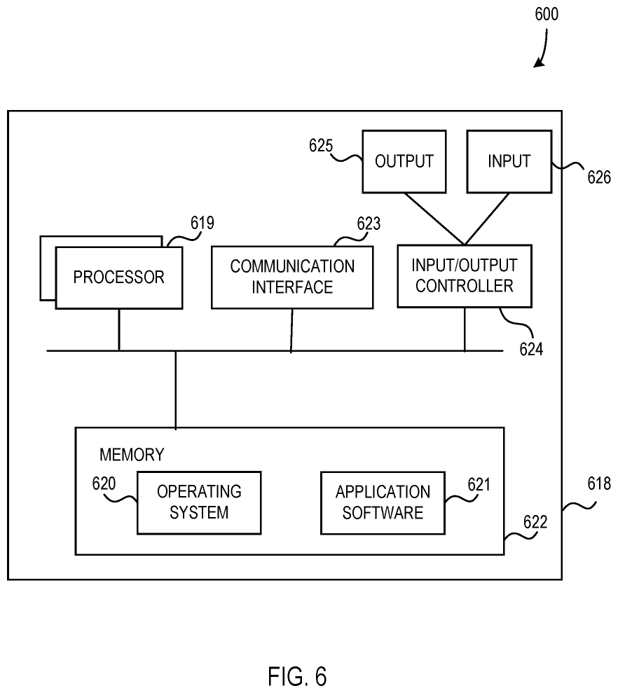

The present disclosure is operable with a computing apparatus according to an embodiment as a functional block diagram 600 in FIG. 6. In an embodiment, components of a computing apparatus 618 may be implemented as a part of an electronic device according to one or more embodiments described in this specification. The computing apparatus 618 comprises one or more processors 619 which may be microprocessors, controllers, or any other suitable type of processors for processing computer executable instructions to control the operation of the electronic device. Alternatively, or in addition, the processor 619 is any technology capable of executing logic or instructions, such as a hardcoded machine. Platform software comprising an operating system 620 or any other suitable platform software may be provided on the apparatus 618 to enable application software 621 to be executed on the device. According to an embodiment, generating benchmarks and presenting associated benchmark visualizations as described herein may be accomplished by software, hardware, and/or firmware.

Computer executable instructions may be provided using any computer-readable media that are accessible by the computing apparatus 618. Computer-readable media may include, for example, computer storage media such as a memory 622 and communications media. Computer storage media, such as a memory 622, include volatile and non-volatile, removable, and non-removable media implemented in any method or technology for storage of information such as computer readable instructions, data structures, program modules or the like. Computer storage media include, but are not limited to, RAM, ROM, EPROM, EEPROM, persistent memory, phase change memory, flash memory or other memory technology, CD-ROM, digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 622) is shown within the computing apparatus 618, it will be appreciated by a person skilled in the art, that the storage may be distributed or located remotely and accessed via a network or other communication link (e.g. using a communication interface 623).

The computing apparatus 618 may comprise an input/output controller 624 configured to output information to one or more output devices 625, for example a display or a speaker, which may be separate from or integral to the electronic device. The input/output controller 624 may also be configured to receive and process an input from one or more input devices 626, for example, a keyboard, a microphone, or a touchpad. In one embodiment, the output device 625 may also act as the input device. An example of such a device may be a touch sensitive display. The input/output controller 624 may also output data to devices other than the output device, e.g. a locally connected printing device. In some embodiments, a user may provide input to the input device(s) 626 and/or receive output from the output device(s) 625.

The functionality described herein can be performed, at least in part, by one or more hardware logic components. According to an embodiment, the computing apparatus 618 is configured by the program code when executed by the processor 619 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system for presenting a benchmark to a target entity comprises: at least one processor; and at least one memory comprising computer program code, the at least one memory and the computer program code configured to, with the at least one processor, cause the at least one processor to: determine a peer group of entities associated with the target entity based on at least one attribute of the target entity, wherein a quantity of entities in the determined peer group meets a peer group threshold associated with the target entity; identify behavior data of the target entity associated with a behavior category and behavior data of the entities of the peer group associated with the behavior category; transform the behavior data of the entities of the peer group using adjustment values, wherein transformed behavior data values of the transformed behavior data differ from corresponding behavior data values of the behavior data of the entities of the peer group by less than an accuracy threshold, whereby the behavior data values of the behavior data of the entities of the peer group are concealed from the target entity in the benchmark; generate benchmark data of the benchmark associated with the behavior category based on the behavior data associated with the target entity and the transformed behavior data associated with the entities of the peer group; and present the benchmark data of the benchmark as a benchmark visualization via a user interface, wherein the benchmark visualization includes a visual representation of the behavior data of the target entity compared to the behavior data of the entities of the peer group.

An example computerized method for presenting a benchmark to a target entity comprises: determining, by a processor, a peer group of entities associated with the target entity based on at least one attribute of the target entity, wherein a quantity of entities in the determined peer group meets a peer group threshold associated with the target entity; identifying, by a processor, behavior data of the target entity associated with a behavior category and behavior data of the entities of the peer group associated with the behavior category; transforming, by a processor, the behavior data of the entities of the peer group using adjustment values, wherein transformed behavior data values of the transformed behavior data differ from corresponding behavior data values of the behavior data of the entities of the peer group by less than an accuracy threshold, whereby the behavior data values of the behavior data of the entities of the peer group are concealed from the target entity in the benchmark; generating, by a processor, benchmark data of the benchmark associated with the behavior category based on the behavior data associated with the target entity and the transformed behavior data associated with the entities of the peer group; and presenting, by a processor, the benchmark data of the benchmark as a benchmark visualization via a user interface, wherein the benchmark visualization includes a visual representation of the behavior data of the target entity compared to the behavior data of the entities of the peer group.

One or more non-transitory computer storage media having computer-executable instructions for presenting a benchmark to a target entity that, upon execution by a processor, causes the processor to at least: determine a peer group of entities associated with the target entity based on at least one attribute of the target entity, wherein a quantity of entities in the determined peer group meets a peer group threshold associated with the target entity; identify behavior data of the target entity associated with a behavior category and behavior data of the entities of the peer group associated with the behavior category; transform the behavior data of the entities of the peer group using adjustment values, wherein transformed behavior data values of the transformed behavior data differ from corresponding behavior data values of the behavior data of the entities of the peer group by less than an accuracy threshold, whereby the behavior data values of the behavior data of the entities of the peer group are concealed from the target entity in the benchmark; generate benchmark data of the benchmark associated with the behavior category based on the behavior data associated with the target entity and the transformed behavior data associated with the entities of the peer group; and present the benchmark data of the benchmark as a benchmark visualization via a user interface, wherein the benchmark visualization includes a visual representation of the behavior data of the target entity compared to the behavior data of the entities of the peer group.

Alternatively, or in addition to the other examples described herein, examples include any combination of the following:
wherein determining the peer group of entities associated with the target entity based on at least one attribute of the target entity includes: identifying entities that match the target entity based on a matching scope of each attribute of the at least one attribute; and based on identifying a quantity of entities that match the target entity and the identified quantity being less than the peer group threshold, expanding at least one matching scope of the at least one attribute and identifying entities that match the target entity based on the expanded at least one matching scope.
wherein the target entity is a company and the at least one attribute includes an employee count attribute and an industry category attribute; wherein identifying entities that match the target entity includes identifying companies that have employee count attributes within a matching scope range of the employee count attribute of the target entity and that have industry category attributes that match the industry category attribute of the target entity; and wherein expanding at least one matching scope of the at least one attribute includes at least one of the following: expanding the matching scope range of the employee count attribute to include an additional range of employee count values and expanding a matching scope of the industry category attribute to include an additional related industry category based on a defined industry relation table.
wherein transforming the behavior data of the entities of the peer group using adjustment values includes transforming behavior data values of the behavior data of the entities of the peer group using random LaPlace noise values.
wherein transforming the behavior data of the entities of the peer group using adjustment values further includes: identifying a theoretical maximum behavior data value based on the behavior data of the entities of the peer group; adjusting behavior data value outliers of the behavior data of the entities of the peer group based on the identified theoretical maximum behavior data value; applying a random LaPlace noise value to each behavior data value of the entities of the peer group to form adjusted behavior data values; calculating an average value of the adjusted behavior data values and an average value of the behavior data values of the entities of the peer group; based on a difference between the average value of the adjusted behavior data values and the average value of the behavior data values of the entities of the peer group exceeding an accuracy threshold, adjusting the average value of the adjusted behavior data values based on the accuracy threshold; and wherein the transformed behavior data associated with the entities of the peer group includes the average value of the adjusted behavior data values and wherein generating the benchmark data of the benchmark is based on the average value of the adjusted behavior data values.
wherein presenting the benchmark data of the benchmark as a benchmark visualization via a user interface includes presenting benchmark data of a set of multiple benchmarks as benchmark visualizations via the user interface, wherein the set of multiple benchmarks includes benchmarks selected based on defined preferences of the target entity.
wherein presenting the benchmark data of the benchmark as a benchmark visualization via a user interface includes presenting benchmark data of a set of multiple benchmarks as benchmark visualizations via the user interface, wherein the set of multiple benchmarks includes benchmarks selected based on at least one of the following: a relative performance of the target entity to the entities of the peer group in a selected benchmark meets a performance threshold, and a change in relative performance of the target entity to the entities of the peer group meets a performance threshold.

Any range or device value given herein may be extended or altered without losing the effect sought, as will be apparent to the skilled person.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for determining, by a processor, a peer group of entities associated with the target entity based on at least one attribute of the target entity, wherein a quantity of entities in the determined peer group meets a peer group threshold associated with the target entity; exemplary means for identifying, by a processor, behavior data of the target entity associated with a behavior category and behavior data of the entities of the peer group associated with the behavior category; exemplary means for transforming, by a processor, the behavior data of the entities of the peer group using adjustment values, wherein transformed behavior data values of the transformed behavior data differ from corresponding behavior data values of the behavior data of the entities of the peer group by less than an accuracy threshold, whereby the behavior data values of the behavior data of the entities of the peer group are concealed from the target entity in the benchmark; exemplary means for generating, by a processor, benchmark data of the benchmark associated with the behavior category based on the behavior data associated with the target entity and the transformed behavior data associated with the entities of the peer group; and exemplary means for presenting, by a processor, the benchmark data of the benchmark as a benchmark visualization via a user interface, wherein the benchmark visualization includes a visual representation of the behavior data of the target entity compared to the behavior data of the entities of the peer group.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for presenting a benchmark to a target entity, the system comprising:
at least one processor; and
at least one memory comprising computer program code, the at least one memory and the computer program code configured to, with the at least one processor, cause the at least one processor to:
determine a peer group of entities associated with the target entity based on at least one attribute of the target entity, wherein a quantity of entities in the determined peer group meets a peer group threshold associated with the target entity;
identify behavior data of the target entity associated with a behavior category and behavior data of the entities of the peer group associated with the behavior category;
transform the behavior data of the entities of the peer group using adjustment values, wherein transformed behavior data values of the transformed behavior data differ from corresponding behavior data values of the behavior data of the entities of the peer group by less than an accuracy threshold, whereby the behavior data values of the behavior data of the entities of the peer group are concealed from the target entity in the benchmark;
generate benchmark data of the benchmark associated with the behavior category based on the behavior data associated with the target entity and the transformed behavior data associated with the entities of the peer group; and
present the benchmark data of the benchmark as a benchmark visualization via a user interface, wherein the benchmark visualization includes a visual representation of the behavior data of the target entity compared to the behavior data of the entities of the peer group.

2. The system of claim 1, wherein determining the peer group of entities associated with the target entity based on at least one attribute of the target entity includes:
identifying entities that match the target entity based on a matching scope of each attribute of the at least one attribute; and
based on identifying a quantity of entities that match the target entity and the identified quantity being less than the peer group threshold, expanding at least one matching scope of the at least one attribute and identifying entities that match the target entity based on the expanded at least one matching scope.

3. The system of claim 2, wherein the target entity is a company and the at least one attribute includes an employee count attribute and an industry category attribute;
wherein identifying entities that match the target entity includes identifying companies that have employee count attributes within a matching scope range of the employee count attribute of the target entity and that have industry category attributes that match the industry category attribute of the target entity; and
wherein expanding at least one matching scope of the at least one attribute includes at least one of the following: expanding the matching scope range of the employee count attribute to include an additional range of employee count values and expanding a matching scope of the industry category attribute to include an additional related industry category based on a defined industry relation table.

4. The system of claim 1, wherein transforming the behavior data of the entities of the peer group using adjustment values includes transforming behavior data values of the behavior data of the entities of the peer group using random LaPlace noise values.

5. The system of claim 4, wherein transforming the behavior data of the entities of the peer group using adjustment values further includes:
identifying a theoretical maximum behavior data value based on the behavior data of the entities of the peer group;
adjusting behavior data value outliers of the behavior data of the entities of the peer group based on the identified theoretical maximum behavior data value;
applying a random LaPlace noise value to each behavior data value of the entities of the peer group to form adjusted behavior data values;
calculating an average value of the adjusted behavior data values and an average value of the behavior data values of the entities of the peer group;
based on a difference between the average value of the adjusted behavior data values and the average value of the behavior data values of the entities of the peer group exceeding an accuracy threshold, adjusting the average value of the adjusted behavior data values based on the accuracy threshold; and
wherein the transformed behavior data associated with the entities of the peer group includes the average value of the adjusted behavior data values and wherein generating the benchmark data of the benchmark is based on the average value of the adjusted behavior data values.

6. The system of claim 1, wherein presenting the benchmark data of the benchmark as a benchmark visualization via a user interface includes presenting benchmark data of a set of multiple benchmarks as benchmark visualizations via the user interface, wherein the set of multiple benchmarks includes benchmarks selected based on defined preferences of the target entity.

7. The system of claim 1, wherein presenting the benchmark data of the benchmark as a benchmark visualization via a user interface includes presenting benchmark data of a set of multiple benchmarks as benchmark visualizations via the user interface, wherein the set of multiple benchmarks includes benchmarks selected based on at least one of the following: a relative performance of the target entity to the entities of the peer group in a selected benchmark meets a performance threshold, and a change in relative performance of the target entity to the entities of the peer group meets a performance threshold.

8. A computerized method for presenting a benchmark to a target entity, the computerized method comprising:
determining, by a processor, a peer group of entities associated with the target entity based on at least one attribute of the target entity, wherein a quantity of entities in the determined peer group meets a peer group threshold associated with the target entity;
identifying, by a processor, behavior data of the target entity associated with a behavior category and behavior data of the entities of the peer group associated with the behavior category;
transforming, by a processor, the behavior data of the entities of the peer group using adjustment values, wherein transformed behavior data values of the transformed behavior data differ from corresponding behavior data values of the behavior data of the entities of the peer group by less than an accuracy threshold, whereby the behavior data values of the behavior data of the entities of the peer group are concealed from the target entity in the benchmark;
generating, by a processor, benchmark data of the benchmark associated with the behavior category based on the behavior data associated with the target entity and the transformed behavior data associated with the entities of the peer group; and
presenting, by a processor, the benchmark data of the benchmark as a benchmark visualization via a user interface, wherein the benchmark visualization includes a visual representation of the behavior data of the target entity compared to the behavior data of the entities of the peer group.

9. The computerized method of claim 8, wherein determining the peer group of entities associated with the target entity based on at least one attribute of the target entity includes:
identifying entities that match the target entity based on a matching scope of each attribute of the at least one attribute; and
based on identifying a quantity of entities that match the target entity and the identified quantity being less than the peer group threshold, expanding at least one matching scope of the at least one attribute and identifying entities that match the target entity based on the expanded at least one matching scope.

10. The computerized method of claim 9, wherein the target entity is a company and the at least one attribute includes an employee count attribute and an industry category attribute;
wherein identifying entities that match the target entity includes identifying companies that have employee count attributes within a matching scope range of the employee count attribute of the target entity and that have industry category attributes that match the industry category attribute of the target entity; and
wherein expanding at least one matching scope of the at least one attribute includes at least one of the following: expanding the matching scope range of the employee count attribute to include an additional range of employee count values and expanding a matching scope of the industry category attribute to include an additional related industry category based on a defined industry relation table.

11. The computerized method of claim 8, wherein transforming the behavior data of the entities of the peer group using adjustment values includes transforming behavior data values of the behavior data of the entities of the peer group using random LaPlace noise values.

12. The computerized method of claim 11, wherein transforming the behavior data of the entities of the peer group using adjustment values further includes:
identifying a theoretical maximum behavior data value based on the behavior data of the entities of the peer group;
adjusting behavior data value outliers of the behavior data of the entities of the peer group based on the identified theoretical maximum behavior data value;
applying a random LaPlace noise value to each behavior data value of the entities of the peer group to form adjusted behavior data values;
calculating an average value of the adjusted behavior data values and an average value of the behavior data values of the entities of the peer group;
based on a difference between the average value of the adjusted behavior data values and the average value of the behavior data values of the entities of the peer group exceeding an accuracy threshold, adjusting the average value of the adjusted behavior data values based on the accuracy threshold; and
wherein the transformed behavior data associated with the entities of the peer group includes the average value of the adjusted behavior data values and wherein generating the benchmark data of the benchmark is based on the average value of the adjusted behavior data values.

13. The computerized method of claim 8, wherein presenting the benchmark data of the benchmark as a benchmark visualization via a user interface includes presenting benchmark data of a set of multiple benchmarks as benchmark visualizations via the user interface, wherein the set of multiple benchmarks includes benchmarks selected based on defined preferences of the target entity.

14. The computerized method of claim 8, wherein presenting the benchmark data of the benchmark as a benchmark visualization via a user interface includes presenting benchmark data of a set of multiple benchmarks as benchmark visualizations via the user interface, wherein the set of multiple benchmarks includes benchmarks selected based on at least one of the following: a relative performance of the target entity to the entities of the peer group in a selected benchmark meets a performance threshold, and a change in relative performance of the target entity to the entities of the peer group meets a performance threshold.

15. One or more non-transitory computer storage media having computer-executable instructions for presenting a benchmark to a target entity that, upon execution by a processor, cause the processor to at least:
determine a peer group of entities associated with the target entity based on at least one attribute of the target entity, wherein a quantity of entities in the determined peer group meets a peer group threshold associated with the target entity;
identify behavior data of the target entity associated with a behavior category and behavior data of the entities of the peer group associated with the behavior category;
transform the behavior data of the entities of the peer group using adjustment values, wherein transformed behavior data values of the transformed behavior data differ from corresponding behavior data values of the behavior data of the entities of the peer group by less than an accuracy threshold, whereby the behavior data values of the behavior data of the entities of the peer group are concealed from the target entity in the benchmark;
generate benchmark data of the benchmark associated with the behavior category based on the behavior data associated with the target entity and the transformed behavior data associated with the entities of the peer group; and
present the benchmark data of the benchmark as a benchmark visualization via a user interface, wherein the benchmark visualization includes a visual representation of the behavior data of the target entity compared to the behavior data of the entities of the peer group.

16. The one or more non-transitory computer storage media of claim 15, wherein determining the peer group of entities associated with the target entity based on at least one attribute of the target entity includes:
identifying entities that match the target entity based on a matching scope of each attribute of the at least one attribute; and
based on identifying a quantity of entities that match the target entity and the identified quantity being less than the peer group threshold, expanding at least one matching scope of the at least one attribute and identifying entities that match the target entity based on the expanded at least one matching scope.

17. The one or more non-transitory computer storage media of claim 16, wherein the target entity is a company and the at least one attribute includes an employee count attribute and an industry category attribute;
wherein identifying entities that match the target entity includes identifying companies that have employee count attributes within a matching scope range of the employee count attribute of the target entity and that have industry category attributes that match the industry category attribute of the target entity; and
wherein expanding at least one matching scope of the at least one attribute includes at least one of the following: expanding the matching scope range of the employee count attribute to include an additional range of employee count values and expanding a matching scope of the industry category attribute to include an additional related industry category based on a defined industry relation table.

18. The one or more non-transitory computer storage media of claim 15, wherein transforming the behavior data of the entities of the peer group using adjustment values includes transforming behavior data values of the behavior data of the entities of the peer group using random LaPlace noise values.

19. The one or more non-transitory computer storage media of claim 18, wherein transforming the behavior data of the entities of the peer group using adjustment values further includes:
identifying a theoretical maximum behavior data value based on the behavior data of the entities of the peer group;
adjusting behavior data value outliers of the behavior data of the entities of the peer group based on the identified theoretical maximum behavior data value;
applying a random LaPlace noise value to each behavior data value of the entities of the peer group to form adjusted behavior data values;
calculating an average value of the adjusted behavior data values and an average value of the behavior data values of the entities of the peer group;
based on a difference between the average value of the adjusted behavior data values and the average value of the behavior data values of the entities of the peer group exceeding an accuracy threshold, adjusting the average value of the adjusted behavior data values based on the accuracy threshold; and
wherein the transformed behavior data associated with the entities of the peer group includes the average value of the adjusted behavior data values and wherein generating the benchmark data of the benchmark is based on the average value of the adjusted behavior data values.

20. The one or more non-transitory computer storage media of claim 15, wherein presenting the benchmark data of the benchmark as a benchmark visualization via a user interface includes presenting benchmark data of a set of multiple benchmarks as benchmark visualizations via the user interface, wherein the set of multiple benchmarks includes benchmarks selected based on defined preferences of the target entity.
